(19) United States
(12) Patent Application Publication
(10) Pub. No.: US 2014/0192406 A1
(43) Pub. Date: Jul. 10, 2014

(54) LASER SCANNING MICROSCOPE HAVING AN ILLUMINATION ARRAY

(71) Applicant: Wolfgang Bathe, Jena (DE)

(72) Inventor: Wolfgang Bathe, Jena (DE)

(73) Assignee: CARL ZEISS MICROSCOPY GMBH, Jena (DE)

(21) Appl. No.: 14/127,544

(22) PCT Filed: Jul. 31, 2012
(86) PCT No.: PCT/EP2012/003254

§ 371 Date: Mar. 10, 2014

(30) Foreign Application Priority Data
Aug. 6, 2011 (DE) 10 2011 109 653.5

(51) Int. Cl. G02B 21/00

(52) U.S. Cl. CPC G02B 21/0032
USPC 359/385

(57) ABSTRACT

The invention relates to a laser scanning microscope (LSM), consisting of at least one light source, from which an illumination beam path in the direction of a sample originates, at least one detection beam path for passing sample light, preferably fluorescence light, onto a detector arrangement, it main colour separator for separating the illumination and detection beam paths, a microlens array for generating a light source grid composed of at least two light sources, a scanner for generating a relative movement between the illumination light and the sample in at least one direction, and a microscope objective, wherein the lens array is arranged in at common part of illumination and detection beam paths.

The invention relates to a laser scanning microscope that scans a sample at multiple spots simultaneously, enabling a shortened imaging time. A microscope of this type is described, for example, in U.S. Pat. No. 6,028,306.

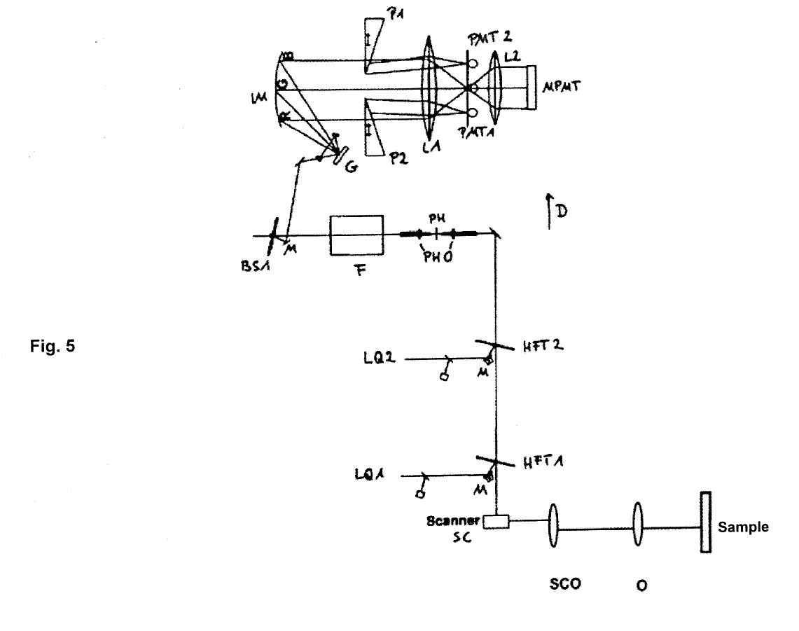

A device for multibeam generation is described, for example, in DE 19904592 A1. FIG. 5 shows an LSM beam path in the ZEISS LSM 710, by way of example. Reference is further made to DE 19702753 A1 as a component of the disclosure, which describes an additional LSM beam path in detail.

A confocal scanning microscope contains a laser module, which preferably consists of multiple laser beam sources that generate illumination light of different wavelengths. A scanning device, into which the illumination light is coupled as an illuminating beam, comprises a main color separator, an x-y scanner and a scanning objective lens and a microscope objective lens for directing the illuminating beam by way of beam deflection over a sample which is located on a microscope stage of a microscope unit. A measuring light beam thereby produced and coming from the sample is directed toward at least one confocal detection aperture (detection pinhole) of at least one detection channel via a main color separator and an imaging lens.

In FIG. 5, the light from two lasers or groups of lasers LQ1 and LQ2 travels through main color separators HFT 1 and HFT 2, respectively, for separating illuminating beam path from detection beam path, which color separators can be embodied as switchable dichroic filter wheels and can also be interchangeable in order to make the selection of wavelengths flexible, first through a scanner, preferably consisting of two independent galvanometric scanning mirrors for X- and Y-deflection, in the direction of scanning optics SCO (not shown) and through said optics and the microscope objective lens O to the sample in a customary fashion. The sample light travels in the reverse direction through separators HFT 1, HFT 2 in the direction of detection D.

Here, the detection light passes first through a pinhole PH via pinhole optics PHO situated upstream and downstream of the pinhole, and through a filter assembly F, consisting, for example, of notch filters for the narrow band filtering out of undesirable beam components, and travels via a beam divider BS, which optionally enables coupling out to external detection modules via a transmissive component with corresponding switching, a mirror M and additional redirecting elements to grid G for the spectral splitting of the detection beam.

The divergent spectral components that have been split by the grid G are collimated by means of an imaging mirror IM and travel in the direction of a detector assembly, which consists of individual detectors PMT 1, PMT 2 in the edge region and a centrally disposed multichannel detector MPMT.

In place of the multichannel detector, an additional single detector may also be used. Two prisms P1, P2, which are displaceable perpendicular to the optical axis, are located in the edge region upstream of a lens L1; said prisms combine a portion of the spectral components which are focused on the individual PMT 1 and 2 via the lens L1. The remaining portion of the detection beam is collimated by a second lens L2 after passing through the plane of PMT1 and 2, and is directed, spectrally separated, toward the individual detection channels of the MPMT.

By displacing the prisms P1, P2, the portion of the sample light that has been spectrally separated and is detected by the MPMT and the portion that has been combined by prisms P1 and P2 and is detected by PMT1 and 2 can be adjusted in a flexible manner.

One limiting factor of laser scanning microscopes is their scanning speed. With current systems, approximately 5-10 images can be scanned under average conditions.

One approach to shortening the imaging time involves the use of resonance scanners. By applying this principle, video rates can be achieved; however, resonance scanners have other disadvantages, such as a fixed scanning frequency, for example. In principle, pixel times at high scanning rates must also be very short, and therefore, the intensity during this time must be very high in order for sufficient light from the sample to be detected. Therefore, LSM having one spot are generally limited in terms of their speed.

Another approach consists in the use of a “spinning disk” system (e.g., Cell Observer SD from Zeiss). These systems use rotating disks with holes which serve as confocal pinholes. The number of holes can be very high, and high imaging rates can be achieved. However, the flexibility of these systems is very low, e.g., the hole size cannot be adjusted. All advantages of an x-y scanner, e.g., variable image sizes and zoom factors, are likewise lost.

The detected light intensity is very low.

The object of the invention is to increase scanning speed while avoiding these described disadvantages.

### DESCRIPTION OF THE INVENTION

The object of the invention is attained by the features of the main claim. Preferred further developments are the subject matter of the dependent claims.

The invention described in the following solves the problem of generating and detecting multiple spots for use in a conventional scanner. By applying the scan with n spots, the imaging time can be shortened to 1/n of the time required by a single-spot scanner. Flexibility is limited only by a predetermined grid of scan spots.

The core element for generating multiple spots is a lens array having n lenses.

In EP 785447 A2, a lens array is provided for filtering during detection. JP 10311950 A describes a microlens array which interacts with a perforated plate as a “pinhole array”.

In U.S. Pat. No. 6,028,306, a pinhole array is likewise used.

According to the invention, a lens array is preferably located between main color separator and scanner, but is in any case located in the common illumination/excitation and detection beam path.

Illumination is provided using a large-area, preferably collimated excitation beam. Thus n foci, corresponding to the number n of lenses, result on the illumination side. All foci can be illuminated telecentrically, in which case the main beam thereof extends parallel to the axis of the optical system.

With an additional lens (multispot objective lens) all foci are collimated, and at the same time, the collimated beams are refracted toward the optical axis of the system. The beams meet—with telecentric illumination of the foci—at the rear focal point of the multispot objective lens.

The scanner for the system can be located at this point. The remaining configuration corresponds to that of a conventional LSM.

Accordingly, a scanning objective lens follows, which generates an intermediate image. This image then no longer contains only one, but n spots on the excitation side. With scanner deflection, these spots are moved together in the intermediate image. The intermediate image is formed in a sample in the conventional manner via the objective lens.

In the sample, particularly fluorescent light is generated as a result of the excitation. This light—as is customary—is imaged in an intermediate image via the objective lens and is descanned by the scanner. The multispot objective lens generates a further intermediate image with separate detection spots. These spots are then imaged individually to infinity by the minilens array.

This individual imaging results in essentially collimated beams of all individual spots. They pass through the main color separators and are preferably imaged in a single pinhole with a pinhole objective. As a result of the previously parallel path, all spots “meet” in the pinhole plane at different angles. It is thereby possible to use the same pinhole for all beams. The diameter of the pinhole may be adjustable, in which case the diameter then acts practically the same on all beams. (The angles of the beams relative to one another are small, and the projected area is nearly the same size for all beams). Once the beams have passed through the pinhole, they are separated again. This enables the separate detection of all beams, each by one dedicated detector.

The essential elements and advantages of the invention are:
the generation of multiple spots using one lens array
the use of the same lens array for the parallel collimation of the detection spots
a common pinhole for multiple detection spots utilizing the available solid angle
a small angle spectrum on the main color separator through parallelization of the beams as a result of the minilens array that is used, which improves the spectral slope steepness of the filters assuming these are dichroic, as is customary.

Detection is also possible using separate beam paths.

In place of the pinhole objective and an individual pinhole, a pinhole lens array and a pinhole array are used. The advantage of this embodiment is less cross-talk between the channels. A slight disadvantage is the higher cost; an additional lens array, particularly a pinhole array, is required. All beam paths must be coordinated precisely with one another so that the pinholes of all spots meet centrally.

The ratio of spot size to distance can be freely determined based upon the size of the lenses of the lens array, the spacing thereof, and the focal length thereof.

The lens array can be advantageously replaced by another.

To achieve optimum excitation efficiency the lenses of the lens array must lie as close as possible to one another, since excitation light that reaches the areas between the lenses is not utilized.

If it is necessary for the filling factor to be low, efficiency can be increased again to the theoretical limit by using a telescope array arranged upstream in the excitation beam path. For this purpose, a telescope array which has a high filling factor on the input side is inserted, which simultaneously diminishes the size of the spots. On the output side, beams are then produced spaced from one another. This spacing is selected based upon the lens array.

In some cases, a scan having fewer spots may be necessary. In principle, the excitation beam path can be easily blinded so that fewer minilenses are illuminated. The remainder of the excitation light is then lost. A better variant results from the use of variable optics that diminish the size of the collimated excitation beam, for example. This is advantageously achieved by inserting an interchangeable collimator. Said collimator contains two lenses, both of which collimate the light out of the fiber. A smaller lens, in exchange for the collimator lens which expands the light from a cross-section that contains multiple individual lenses, generates a bundle of beams that illuminates only one lens of the lens array. This results in only one spot, in which case the entire system acts as a conventional LSM. The excitation intensity of the one spot can be n times greater. On the detection side, it is sufficient only to read out the corresponding detector. Nevertheless, the other detectors can also be read out in order to obtain additional information regarding the thickness of the sample, for example.

The generation of spots could also be shifted in the illumination direction upstream of the HFT. In that case, separate foci result on the detection side, which can be discriminated using a pinhole array. Such a variant minimizes the number of components in the detection beam path, thereby minimizing detection light losses. However, costly components are required, and the errors of the minilens array are not compensated for since such an array is used only on the excitation side.

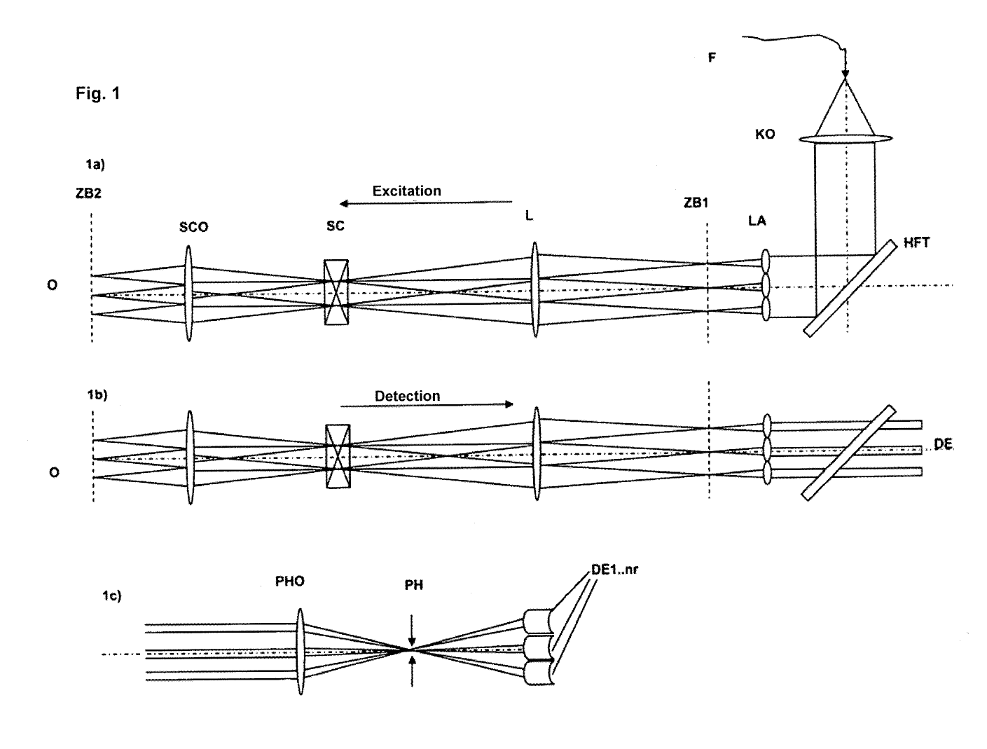

In the following, the advantageous embodiments of the invention will be specified in greater detail in reference to FIG. 1-4.

The following reference signs are used:
F: fiber
KO: fiber collimator lens
Hft.: main color separator of the microscope
LA 1 . . . n>: lens array comprising n individual lenses
L: multispot lens
SC: scanner
SCO: scanning objective lens
ZB: intermediate image
O: microscope objective lens
DE: detection beam path
PHO: pinhole objective
PH: individual pinhole
ZB1, ZB2: intermediate image planes
DE1.n: detector array comprising n individual detectors
PHA: pinhole array
MLAPH: pinhole microlens array
MLT: minilens telescope
AW: interchangeable collimator

Common to FIGS. 1-4 is that, in each case, part a) shows the illumination direction toward the sample, part b) shows the detection direction of the detected sample light, and part c) shows the beam path upstream of the detector.

Each of the elements indicated in FIGS. 1a), 2a), 3a) and 4a) by the reference signs are components of FIGS. 1b, 2b, 3b and 4b, accordingly without reference signs. The illumination light emerges divergent from a fiber F and travels, collimated by a collimator KO and reflected by the main color separator HFT of the microscope in the direction of the sample, to a lens array LA. The illumination spots generated in an intermediate image ZB1 by the LA are collimated via the multispot lens L and refracted toward the optical axis, and meet, with telecentric illumination, at the rear focal point of L where the scanner SC is arranged.

The foci generated in the intermediate image ZB2 downstream of the scanning objective lens SCO are further imaged on the sample via the microscope objective lens O (not shown), whereby the illumination points are moved to the sample via the at least unidimensional scanner.

The light coming from the sample travels through the same elements in the direction of detection DE, which is illustrated in detail in part c) of each figure. The illumination and detection beam paths at the HFT can also be interchanged so that the illumination light, transmitted by the HFT, travels in the direction of the sample, and the HFT reflects the sample light in the direction of detection.

In FIG. 1c), the individual beams that are collimated after passing through the LA are focused by a pinhole objective in the plane of a pinhole, and therefore, only a single pinhole is required.

Detectors DE 1 . . . n that correspond to the individual illuminated sample points lie in the double focal length of the PHO for detecting the fluorescence distribution generated on the sample.

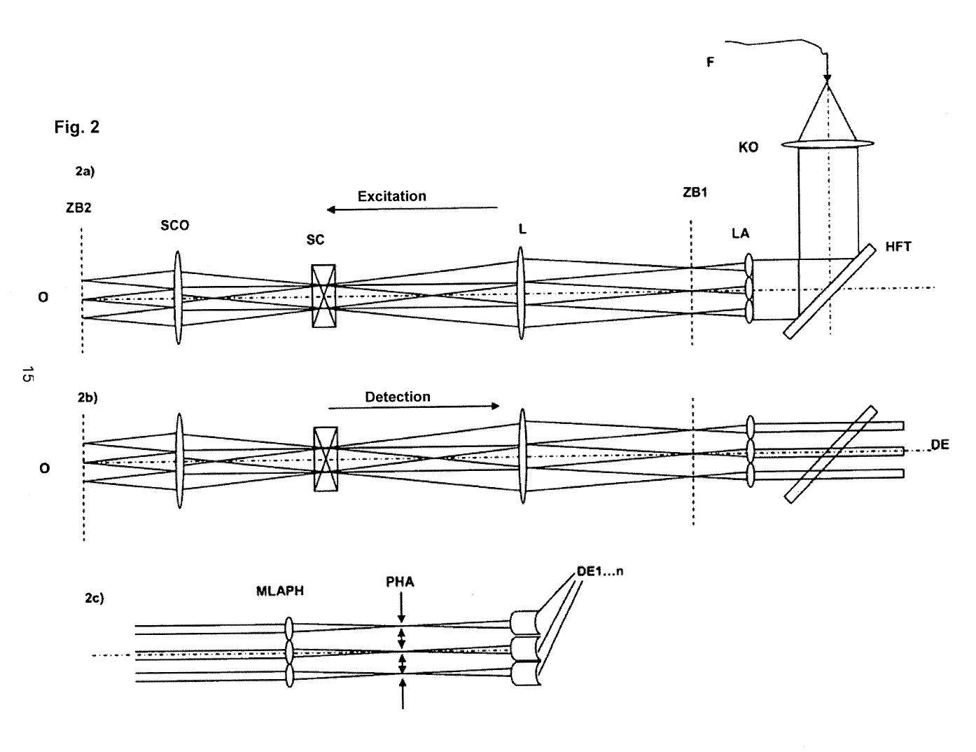

In FIG. 2c, in place of the individual pinhole in the focal points of the microlenses of the LA, a pinhole array is used, downstream of which a detector array DE1-n is in turn arranged.

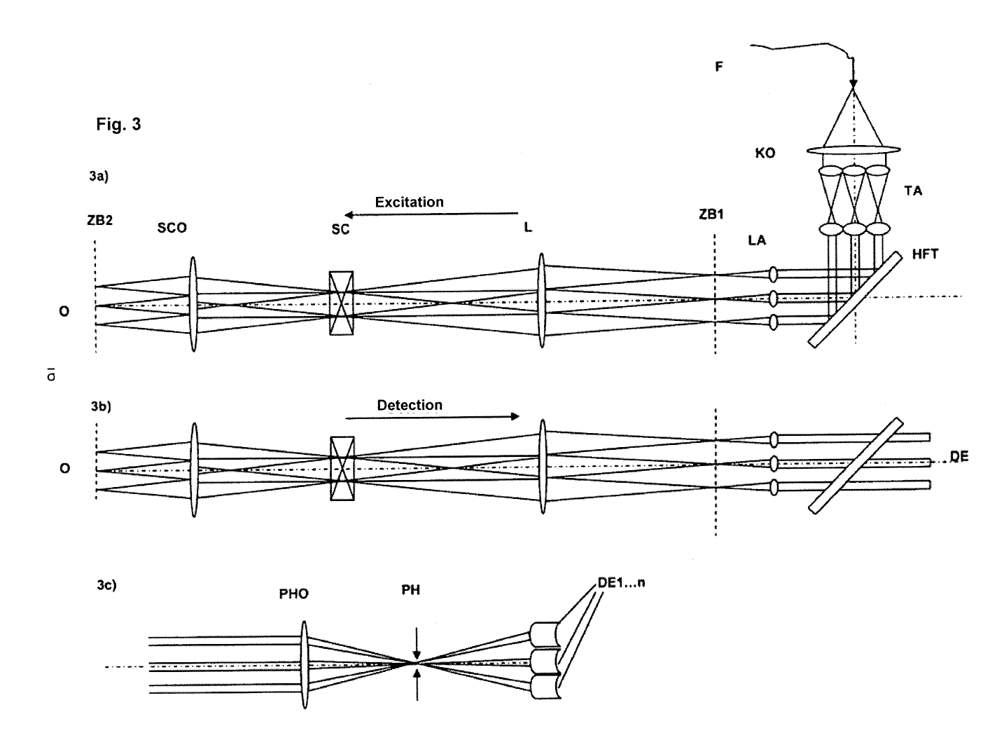

In FIG. 3a, a telescope array consisting of two minilens arrays arranged one in front of the other is additionally situated downstream of the fiber collimator KO upstream of the HFT for generating individual collimated beams, which in turn travel via the MLA in the direction of the sample.

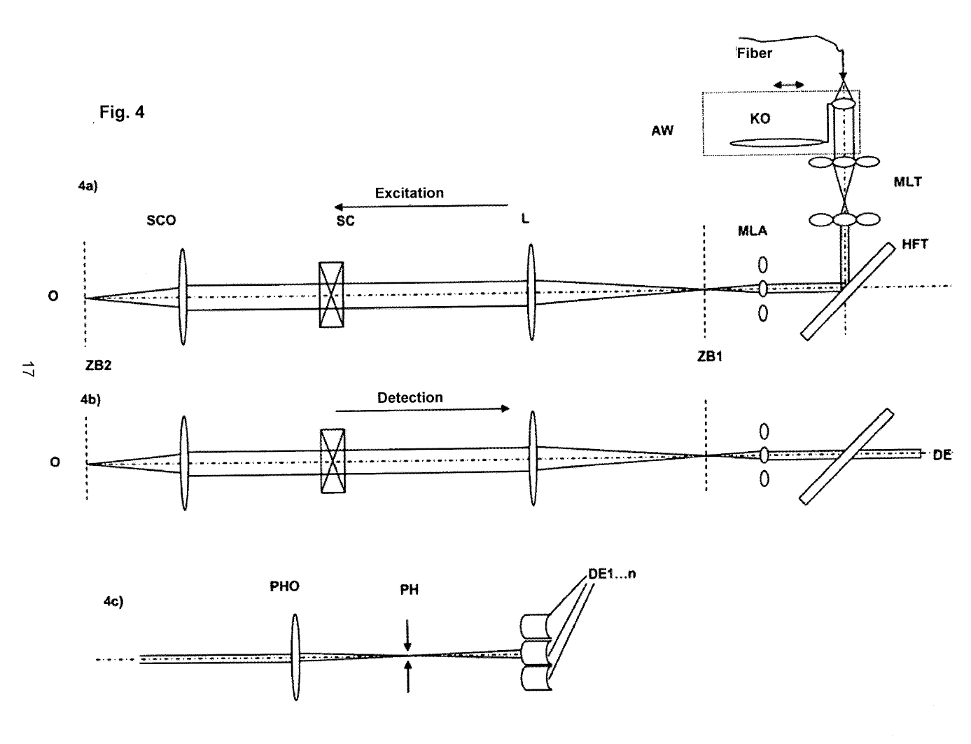

FIG. 4a shows an interchangeable unit AW indicated by a dashed line, which unit is intended to be interchanged with the collimator of FIG. 1 and a single lens for generating a single centered beam that passes through only one central axis and one lens in the TA and in the LA, said interchangeable unit generating a point illumination on the sample.

In this manner, a switch can easily be made between a single-point LSM and a multi-point LSM.

The described embodiments of the invention can be implemented in any LSM beam path.

In the beam path according to FIG. 5, this implementation would be possible downstream of any of the main color separators HFT1 or HFT2 shown, upstream of the scanner in the illumination direction.

The invention is not limited to the described embodiments, and can instead be advantageously further embodied in a routine manner.

1. A laser scanning microscope (LSM) comprising:
at least one light source from which an illuminating beam path originates in the direction of a sample;
at least one detection beam path for passing sample light onto a detector arrangement;
a main color separator for separating the illumination and detection beam paths;
a microlens array for generating a light source grid comprising at least two light sources;
a scanner for generating a relative movement between the illumination light and the sample in at least one direction; and
a microscope objective lens,
wherein the microlens array is arranged in a common part of the illumination and detection beam paths.

2. The laser scanning microscope according to claim 1, wherein the microlens array is arranged between the main color separator and the scanner.

3. The laser scanning microscope according to claim 1,
wherein optics for generating an expanded light beam comprising a plurality of lenses of the microlens array in cross-section are situated upstream of the microlens array in the illumination direction.

4. The laser scanning microscope according to claim 1,
wherein transfer optics for transferring the illumination points generated by the mini-lenses from the expanded light beam via the scanner and scanning optics to an intermediate image are provided upstream of the microscope objective lens.

5. The laser scanning microscope according to claim 1,
wherein in the detection direction, the individual beams of sample light generated by the illumination grid by at least one of excitation, scattering and reflection and collimated by the microlens array are focused via a pinhole optic in a single pinhole.

6. The laser scanning microscope according to claim 1,
wherein in the detection direction, the individual beams collimated by the microlens array are focused individually via a second lens assembly individually onto pinholes of a pinhole array.

7. The laser scanning microscope according to claim 5,
wherein a detector assembly which assigns a detector to each individual beam is situated downstream of the pinhole.

8. The laser scanning microscope according to claim 6,
wherein a third lens assembly for generating collimated individual beams that strike the individual lenses of the microlens array is provided upstream of the pinhole array.

9. The laser scanning microscope according to claim 8,
wherein the third lens assembly consists of two lens grids which generate a telescopic beam path of individual beams.

10. The laser scanning microscope according to claim 1,
wherein in illumination, a switch-over unit for switching between single-point illumination and multi-point illumination is provided.

11. The laser scanning microscope according to claim 1,
wherein the sample light is fluorescent light.

12. The laser scanning microscope according to claim 8,
wherein the third lens assembly for generating collimated individual beams that strike the individual lenses of the lens array is provided upstream of the main color separator in the direction of illumination.
